(19) United States
(12) Patent Application Publication
(10) Pub. No.: US 2022/0286927 A1
(43) Pub. Date: Sep. 8, 2022

(54) METHOD AND APPARATUS FOR SUPPORT OF MACHINE LEARNING OR ARTIFICIAL INTELLIGENCE TECHNIQUES FOR HANDOVER MANAGEMENT IN COMMUNICATION SYSTEMS

(71) Applicant: Samsung Electronics Co., Ltd., Suwon-si (KR)

(72) Inventors: Pranav Madadi, Sunnyvale, CA (US); Qiaoyang Ye, San Jose, CA (US); Jeongho Jeon, San Jose, CA (US); Joonyoung Cho, Portland, OR (US)

(21) Appl. No.: 17/651,562

(22) Filed: Feb. 17, 2022

Related U.S. Application Data
(60) Provisional application No. 63/158,166, filed on Mar. 8, 2021.

(51) Int. Cl. H04W 36/00; H04W 36/32; H04L 41/16; H04L 41/046

(52) U.S. Cl. CPC H04W 36/00837; H04W 36/0058; H04W 36/32; H04L 41/16; H04L 41/046

(57) ABSTRACT

Configuration information for a machine learning handover event may be used by an artificial intelligence/machine learning agent configured to determine whether to initiate handover. The determination of whether to initiate handover according to the received configuration information for the machine learning handover event is based on one or more of: signal quality for one or more serving base stations, signal quality for one or more neighboring base stations, a velocity of the UE, a location of the UE, and a trajectory of the UE.

### CROSS-REFERENCE TO RELATED APPLICATION AND CLAIM OF PRIORITY

This application claims priority under 35 U.S.C. § 119(e) to U.S. Provisional Patent Application No. 63/158,166 filed Mar. 8, 2021. The above-identified patent document(s) are incorporated herein by reference.

### TECHNICAL FIELD

The present disclosure relates generally to handover for terminals in a wireless communications network, and more specifically to implementation of AI/ML approaches to such handover.

### BACKGROUND

To meet the demand for wireless data traffic having increased since deployment of 4^{th} Generation (4G) or Long Term Evolution (LTE) communication systems and to enable various vertical applications, efforts have been made to develop and deploy an improved 5^{th} Generation (5G) and/or New Radio (NR) or pre-5G/NR communication system. Therefore, the 5G/NR or pre-5G/NR communication system is also called a “beyond 4G network” or a “post LTE system.” The 5G/NR communication system is considered to be implemented in higher frequency (mmWave) bands, e.g., 28 giga-Hertz (GHz) or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and technologies associated therewith is for reference as certain embodiments of the present disclosure may be implemented in 5G systems, 6^{th} Generation (6G) systems, or even later releases which may use terahertz (THz) bands. However, the present disclosure is not limited to any particular class of systems or the frequency bands associated therewith, and embodiments of the present disclosure may be utilized in connection with any frequency band. For example, aspects of the present disclosure may also be applied to deployment of 5G communication systems, 6G communications systems, or communications using THz bands.

### SUMMARY

A framework provides support for AI/ML techniques to enable optimization of handover management in wireless communication systems.

In one embodiment, a user equipment (UE) includes a transceiver configured to receive configuration information for a machine learning handover event. The UE also includes a processor executing an artificial intelligence/machine learning agent configured to determine whether to initiate handover according to the received configuration information for the machine learning handover event based on one or more of: signal quality for one or more serving base stations, signal quality for one or more neighboring base stations, a velocity of the UE, a location of the UE, and a trajectory of the UE.

In another embodiment, a base station (BS) includes a transceiver configured to transmit configuration information for a machine learning handover event. The BS also includes a processor executing an artificial intelligence/machine learning agent configured to determine whether to initiate handover according to the received configuration information for the machine learning handover event based on one or more of: signal quality for one or more serving base stations, signal quality for one or more neighboring base stations, a velocity of the UE, a location of the UE, and a trajectory of the UE.

In any of the preceding embodiments, the configuration information for the machine learning handover event may include at least one of an inference interval specifying a trigger time at which the artificial intelligence/machine learning agent determines whether to initiate handover or a reporting interval specifying a periodicity at which the UE reports machine learning parameters for machine learning handover.

In any of the preceding embodiments, the configuration information for the machine learning handover event may include machine learning inference information specifying factors used by the artificial intelligence/machine learning agent to determine whether to initiate handover.

In any of the preceding embodiments, the determination of whether to initiate handover may be based on a new event A7 defined by an event threshold, a trigger condition, and a cancel condition.

In any of the preceding embodiments, UE capability information including support for machine learning handover may be transmitted to the BS.

In any of the preceding embodiments, the configuration information for the machine learning handover event may include one or more of enabling or disabling of machine learning handover, a machine learning model to be used for machine learning handover, updated machine learning parameters for machine learning handover, or whether parameters received from the UE will be used for machine learning handover.

In any of the preceding embodiments, the configuration information may be transmitted via UE-specific remote resource control (RRC) signaling, where model parameters for a machine learning model to be used for machine learning handover may be transmitted via one of physical uplink control channel (PUCCH), physical uplink shared channel (PUSCH), uplink control information (UCI), or medium access control—control element (MAC-CE).

In any of the preceding embodiments, the configuration information may indicate a parameter for a machine learning handover event to be reported in measurement reporting.

In any of the preceding embodiments, the determination of whether to initiate handover may be performed by one of a serving base station or a network entity, and control signaling initiating handover may be transmitted by one of: a downlink control information (DCI) in one of a physical downlink control channel (PDCCH) or a physical downlink shared channel (PDSCH), a group-common DCI, based on a group-specific radio network temporary identifier (RNTI) configured by remote resource control (RRC) signaling, or a handover command message.

In any of the preceding embodiments, the determination of whether to initiate handover may be made based on assistance information including one of UE location and UE trajectory, where the assistance information may be transmitted via one of physical uplink control channel (PUCCH), physical uplink shared channel (PUSCH), uplink control information (UCI), or medium access control—control element (MAC-CE), and the assistance information may be transmitted one of periodically, semi-persistently, or aperiodically.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an exemplary networked system leveraging AI/ML algorithms to optimize the handover management procedures according to embodiments of this disclosure;

FIG. 2 illustrates an exemplary base station (BS) for communicating in the networked computing system leveraging AI/ML algorithms to optimize the handover management procedures according to embodiments of this disclosure;

FIG. 3 illustrates an exemplary electronic device for communicating in the networked computing system leveraging AI/ML algorithms to optimize the handover management procedures according to embodiments of this disclosure;

FIG. 4 illustrates a high level flowchart for an example of BS operation to support ML/AI techniques for handover management according to various embodiments of this disclosure;

FIG. 5 illustrates a high level flowchart for an example of UE operation to support ML/AI techniques for optimal handover management, where UE performs the inference operation according to various embodiments of this disclosure;

FIG. 6 illustrates a high level flowchart for an example of BS operation to support ML/AI techniques handover, with new design of measurement report contents according to various embodiments of this disclosure;

FIG. 7 illustrates a high level flowchart for an example of UE operation to support ML/AI techniques for handover, with new design of measurement report contents according to various embodiments of this disclosure;

FIG. 8 illustrates a high level flowchart for an example of BS operation to support AI/ML techniques for handover, where no inference is performed at UE according to various embodiments of this disclosure; and

FIG. 9 illustrates a high level flowchart for an example of UE operation to support AI/ML techniques for handover, where no inference is performed at UE according to various embodiments of this disclosure.

### DETAILED DESCRIPTION

The figures included herein, and the various embodiments used to describe the principles of the present disclosure are by way of illustration only and should not be construed in any way to limit the scope of the disclosure. Further, those skilled in the art will understand that the principles of the present disclosure may be implemented in any suitably arranged wireless communication system.

### REFERENCES

[1] 3GPP TS 38.331 Rel-16 v16.3.1, “NR; Radio Resource Control (RRC) protocol specification,” January 2021.
   The above-identified reference(s) are incorporated herein by reference.

### Abbreviations

ML Machine Learning

AI Artificial Intelligence

gNB Base Station

UE User Equipment

NR New Radio

SCell Secondary Cell

SpCell Special Cell

PCell Primary Cell

RAT Radio Access Technology

3GPP 3rd Generation Partnership Project

RRC Radio Resource Control

DL Downlink

UL Uplink

LTE Long-Term Evolution

RSRP Reference Signal Received Power

RSRQ Reference Signal Received Quality

SINR Signal to Interference and Noise Ratio

In the current 3GPP specification, the connected mode handover decision, i.e., the determination of whether a UE will initiate or perform a handover is made by a base station based on measurement reports from the UE. Multiple measurement items (RSRP, RSRQ, SINR) at cell/beam level and multiple ways (periodic, event triggered) to measure the signal quality of the serving cell and neighbor cells.

Ideally a network let UE to report the signal quality (usually RSRP) of the current cell (serving cell) and target cell and sets the arbitrary rule for handover. But this can be too complicated and adding too much overhead since the network may need multiple consecutive measurement results instead of using only a single or a couple of measured signal quality value.

To overcome this challenge, 3GPP specifications have proposed a set of predefined measurement report mechanisms to be performed by UE. These predefined measurement report types are called “Event”. The type of “event” a UE have to report is specified by RRC signaling message sent by the base station. Following are the events defined by 3GPP specifications. [1]
Event A1 (Serving becomes better than threshold)
Event A2 (Serving becomes worse than threshold)
Event A3 (Neighbor becomes offset better than SpCell)
Event A4 (Neighbor becomes better than threshold)
Event A5 (SpCell becomes worse than threshold1 and neighbor becomes better than threshold2)
Event A6 (Neighbour becomes offset better than SCell)
Event B1 (Inter RAT neighbour becomes better than threshold)
Event B2 (PCell becomes worse than threshold) and inter RAT neighbor becomes better than threshold2)

Measurement Report is triggered by whether the measured value crosses (goes higher or goes lower) a certain target value. The target value can be set by one of two methods. One is to use threshold which is a kind of absolute value and the other one is to use offset value which is a kind of relative value with a reference to something like serving cell value. In this invention, we leverage AI/ML algorithms to optimize the handover management procedures, including design of triggering method for the measurement reports in the RRC connected mode, the contents of the measurement reports, and method for signaling handover command.

Application of artificial intelligence (AI)/machine learning (ML) algorithms in communication networks has drawn a lot of interest. It has been stated that AI/ML algorithms will be used for deployment of 5G networks in both the network and UE side. In general, AI is a tool to help network to make a quicker and wiser decision based on training data in the past. The potential benefits of standardization support are feedback/control signaling overhead reduction, more accurate feedback and enabling better AI algorithms which require coordination between base station and UE. These potential benefits will then translate to better system performance, e.g., in terms of throughput and reliability.

The present disclosure presents a framework to support AI/ML techniques in wireless communication systems, especially at base station and UE to enable optimization of handover management. Corresponding signaling details are discussed in this disclosure.

The present disclosure relates to the support of ML/AI techniques in a communication system for specific purpose of optimizing the procedures related to connected mode handover mechanism. Techniques, apparatus and methods are disclosed for configuration of ML/AI approaches for handover operation, specifically the detailed configuration method for various ML/AI algorithms and corresponding model parameters, UE capability negotiation for ML/AI operations, and signaling method for the support of training and inference operations at different components in the system have been discussed.

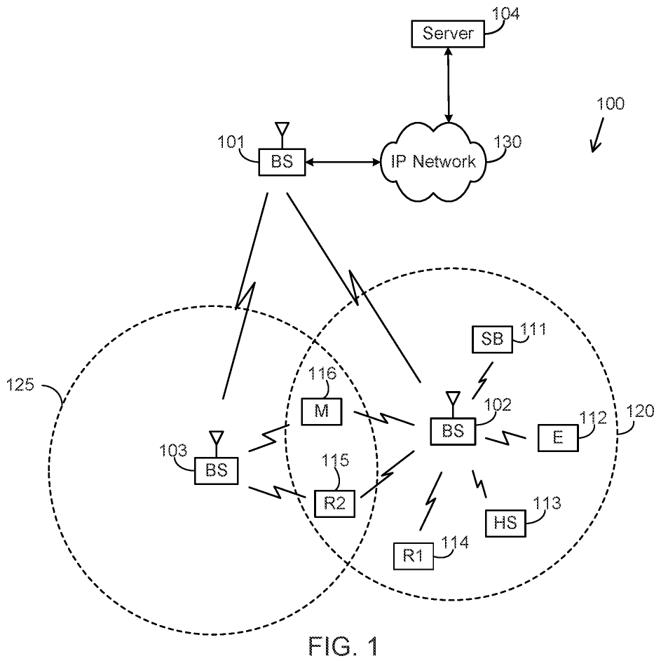

FIG. 1 illustrates an exemplary networked system leveraging AI/ML algorithms to optimize the handover management procedures according to various embodiments of this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a base station (BS) 101, a BS 102, and a BS 103. The BS 101 communicates with the BS 102 and the BS 103. The BS 101 also communicates with at least one Internet protocol (IP) network 130, such as the Internet, a proprietary IP network, or another data network. Each BS 101, 102 and 103 may be terrestrial, and the wireless network 100 may be a terrestrial network, or at least BS 102 and/or BS 103 may be non-terrestrial (e.g., airborne or spaceborne), and the wireless network 100 may be an NTN, in embodiments of the present disclosure.

The BS 102 provides wireless broadband access to the network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R1); a UE 115, which may be located in a second residence (R2); and a UE 116, which may be a mobile device (M) like a cell phone, a wireless laptop, a wireless PDA, or the like. One or more of UEs 111, 112, 113, 114, 115, and 116 may be moving at high speed relative to BS 102 and/or BS 103, such as on a high speed train, in embodiments of the present disclosure. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G, LTE, LTE Advanced (LTE-A), WiMAX, WiFi, NR, or other wireless communication techniques.

Depending on the network type, other well-known terms may be used instead of “base station” or “BS,” such as node B, evolved node B (“eNodeB” or “eNB”), a 5G node B (“gNodeB” or “gNB”) or “access point.” For the sake of convenience, the terms “base station” and/or “BS” are used in this disclosure to refer to network infrastructure components that provide wireless access to remote terminals. Also, depending on the network type, other well-known terms may be used instead of “user equipment” or “UE,” such as “mobile station” (or “MS”), “subscriber station” (or “SS”), “remote terminal,” “wireless terminal,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extent of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

Although FIG. 1 illustrates one example of a wireless network 100, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BS 101, 102, and/or 103 could provide access to other or additional external networks, such as external telephone networks or other types of data networks.

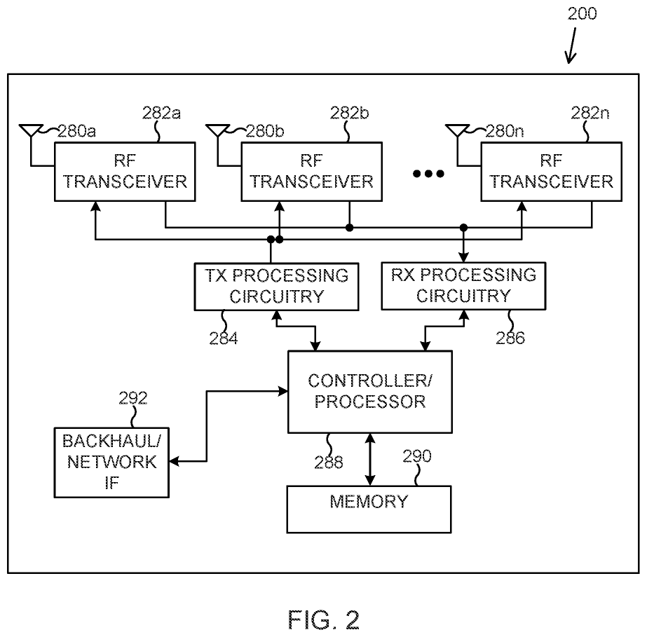

FIG. 2 illustrates an exemplary base station (BS) for communicating in the networked computing system leveraging AI/ML algorithms to optimize the handover management procedures according to various embodiments of this disclosure. The embodiment of the BS 200 illustrated in FIG. 2 is for illustration only, and the BSs 101, 102 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 200 includes multiple antennas 280a-280n, multiple radio frequency (RF) transceivers 282a-282n, transmit (TX or Tx) processing circuitry 284, and receive (RX or Rx) processing circuitry 286. The BS 200 also includes a controller/processor 288, a memory 290, and a backhaul or network interface 292.

The RF transceivers 282a-282n receive, from the antennas 280a-280n, incoming RF signals, such as signals transmitted by UEs in the network 100. The RF transceivers 282a-282n down-convert the incoming RF signals to generate IF or baseband signals. The IF or baseband signals are sent to the RX processing circuitry 286, which generates processed baseband signals by filtering, decoding, and/or digitizing the baseband or IF signals. The RX processing circuitry 286 transmits the processed baseband signals to the controller/processor 288 for further processing.

The TX processing circuitry 284 receives analog or digital data (such as voice data, web data, e-mail, or interactive video game data) from the controller/processor 288. The TX processing circuitry 284 encodes, multiplexes, and/or digitizes the outgoing baseband data to generate processed baseband or IF signals. The RF transceivers 282a-282n receive the outgoing processed baseband or IF signals from the TX processing circuitry 284 and up-converts the baseband or IF signals to RF signals that are transmitted via the antennas 280a-280n.

The controller/processor 288 can include one or more processors or other processing devices that control the overall operation of the BS 200. For example, the controller/processor 288 could control the reception of forward channel signals and the transmission of reverse channel signals by the RF transceivers 282a-282n, the RX processing circuitry 286, and the TX processing circuitry 284 in accordance with well-known principles. The controller/processor 288 could support additional functions as well, such as more advanced wireless communication functions and/or processes described in further detail below. For instance, the controller/processor 288 could support beam forming or directional routing operations in which outgoing signals from multiple antennas 280a-280n are weighted differently to effectively steer the outgoing signals in a desired direction. Any of a wide variety of other functions could be supported in the BS 200 by the controller/processor 288. In some embodiments, the controller/processor 288 includes at least one microprocessor or microcontroller.

The controller/processor 288 is also capable of executing programs and other processes resident in the memory 290, such as a basic operating system (OS). The controller/processor 288 can move data into or out of the memory 290 as required by an executing process.

The controller/processor 288 is also coupled to the backhaul or network interface 292. The backhaul or network interface 292 allows the BS 200 to communicate with other devices or systems over a backhaul connection or over a network. The interface 292 could support communications over any suitable wired or wireless connection(s). For example, when the BS 200 is implemented as part of a cellular communication system (such as one supporting 6G, 5G, LTE, or LTE-A), the interface 292 could allow the BS 200 to communicate with other BSs over a wired or wireless backhaul connection. When the BS 200 is implemented as an access point, the interface 292 could allow the BS 200 to communicate over a wired or wireless local area network or over a wired or wireless connection to a larger network (such as the Internet). The interface 292 includes any suitable structure supporting communications over a wired or wireless connection, such as an Ethernet or RF transceiver.

The memory 290 is coupled to the controller/processor 288. Part of the memory 290 could include a RAM, and another part of the memory 290 could include a Flash memory or other ROM.

As described in more detail below, base stations in a networked computing system can be assigned as synchronization source BS or a slave BS based on interference relationships with other neighboring BSs. In some embodiments, the assignment can be provided by a shared spectrum manager. In other embodiments, the assignment can be agreed upon by the BSs in the networked computing system. Synchronization source BSs transmit OSS to slave BSs for establishing transmission timing of the slave BSs.

Although FIG. 2 illustrates one example of BS 200, various changes may be made to FIG. 2. For example, the BS 200 could include any number of each component shown in FIG. 2. As a particular example, an access point could include a number of interfaces 292, and the controller/processor 288 could support routing functions to route data between different network addresses. As another particular example, while shown as including a single instance of TX processing circuitry 284 and a single instance of RX processing circuitry 286, the BS 200 could include multiple instances of each (such as one per RF transceiver). Also, various components in FIG. 2 could be combined, further subdivided, or omitted and additional components could be added according to particular needs.

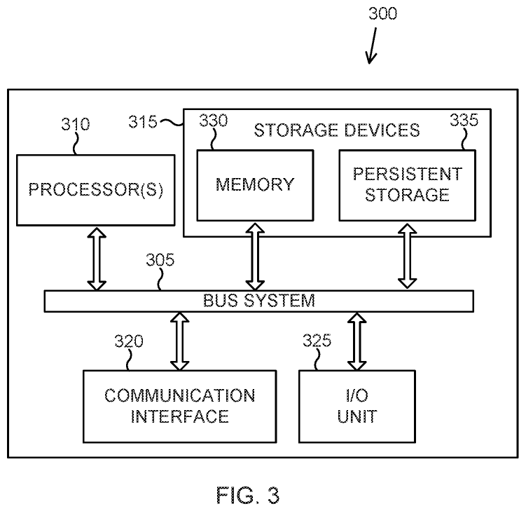

FIG. 3 illustrates an exemplary electronic device for communicating in the networked computing system leveraging AI/ML algorithms to optimize the handover management procedures according to various embodiments of this disclosure. In one embodiment, the electronic device 300 is a user equipment implemented as a mobile device, which can represent one of the UEs 111, 112, 113, 114, 115 and 116 in FIG. 1.

As shown in FIG. 3, the electronic device 300 includes a bus system 305, which supports communication between at least one processing device 310, at least one storage device 315, at least one communications unit 320, and at least one input/output (I/O) unit 325.

The processing device 310 executes instructions that may be loaded into a memory 330. The processing device 310 may include any suitable number(s) and type(s) of processors or other devices in any suitable arrangement. Example types of processing devices 310 include microprocessors, microcontrollers, digital signal processors, field programmable gate arrays, application specific integrated circuits, and discreet circuitry.

The memory 330 and a persistent storage 335 are examples of storage devices 315, which represent any structure(s) capable of storing and facilitating retrieval of information (such as data, program code, and/or other suitable information on a temporary or permanent basis). The memory 330 may represent a random access memory or any other suitable volatile or non-volatile storage device(s). The persistent storage 335 may contain one or more components or devices supporting longer-term storage of data, such as a ready only memory, hard drive, Flash memory, or optical disc.

The communications unit 320 supports communications with other systems or devices. For example, the communications unit 320 could include a network interface card or a wireless transceiver facilitating communications over the network 130. The communications unit 320 may support communications through any suitable physical or wireless communication link(s).

The I/O unit 325 allows for input and output of data. For example, the I/O unit 325 may provide a connection for user input through a keyboard, mouse, keypad, touchscreen, or other suitable input device. The I/O unit 325 may also send output to a display, printer, or other suitable output device.

Although FIG. 3 illustrates an example of an electronic device 300 in a wireless system including a plurality of such electronic devices, such as UEs 111, 112, 113, 114, 115 and 116 in FIG. 1, various changes may be made to FIG. 3. For example, various components in FIG. 3 can be combined, further subdivided, or omitted and additional components could be added according to particular needs. In addition, as with computing and communication networks, electronic devices can come in a wide variety of configurations, and FIG. 3 does not limit this disclosure to any particular electronic device.

The disclosed designs below can be applied not only to NTN systems, but also to any other wireless communication systems implemented as illustrated by FIGS. 1 through 3. The examples for NTN systems should be considered in inclusive manner, without exclusion of other wireless communication systems. For example, the disclosed methods can be applied to both LTE and NR, or any future or existing communication systems with high mobility at either UEs, BSs or both.

The embodiments of the disclosure are applicable in general to any communication system leveraging ML/AI techniques for optimizing handover management procedures.

In one embodiment, the design of a new triggering event for measurement reporting is disclosed.

In the current 3GPP specifications, use of a set of predefined measurement report mechanism to be performed by the UE is proposed. The predefined measurement report type is called “Event.” Each of these events has conditions for entering and existing the event. These conditions are threshold based mathematical inequalities, e.g., RSRP of the serving cell is better than a threshold. These inequalities have been carefully designed. For example, to deal with the fluctuation in the measured RSRP, the parameter “hysteresis” is introduced. When enabled, even though the measured value fluctuates around the threshold, the measurement report is not triggered until the measured value fluctuates beyond the set “Hysteresis” parameter.

With advancement in AI/ML techniques, one can think beyond the triggering conditions based on predefined threshold values. For example, a specific UE can use local data such as velocity, trajectory, location, RSRP of serving cells and neighboring cells to train a local AI/ML model that can learn when it is optimal to make a handover. Given the decisions about connected mode handovers are taken by the BS, based on local ML inferences, the UE can send measurement report to BS suggesting a handover.

To that extent, an intelligent AI/ML assisted measurement reporting capability is proposed that introduces a new measurement report type “Event A7.” The overall framework supporting the AI/ML assisted handover management optimization is as follows:

In one embodiment, the framework to support ML/AI techniques can include the model training done in federated fashion at multiple UE's with the model being updated at the BS side and the inference operation done at the UE side.

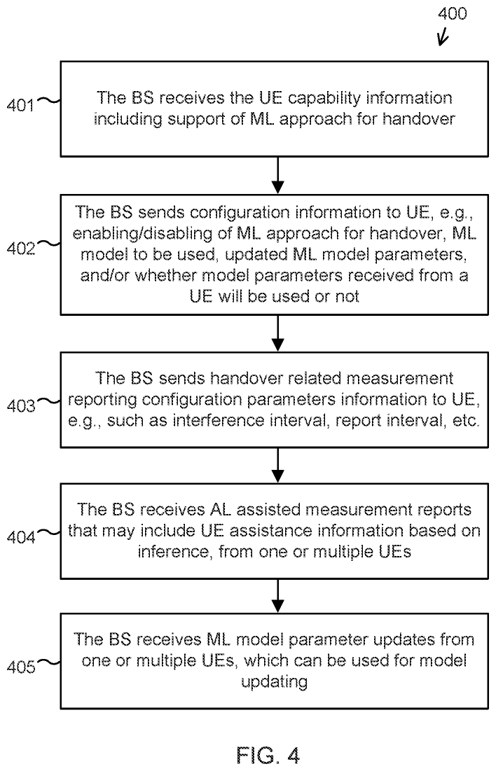

FIG. 4 illustrates a high level flowchart for an example of BS operation to support ML/AI techniques for handover management according to various embodiments of this disclosure. The embodiment of FIG. 4 is for illustration only. Other embodiments of the process 400 could be used without departing from the scope of this disclosure.

FIG. 4 is an example of a method 400 for operations at BS side to support handover management using ML/AI techniques. At operation 401, a BS receives the UE capability information, e.g., the support for the ML approach for connected mode handover management, as is subsequently described in the “Configuration method” section.

At operation 402, the BS sends the configuration information to UE, which can include information about the AI/ML model used for the federated learning, ML/AI related configuration information such as enabling/disabling of ML approach for handover, the trained model parameters of the model, and/or whether the local updated model parameters received from a UE will be used or not, etc. In one embodiment, the model training can be performed at BS side. Alternatively, the model training can be performed at another network entity—e.g., a radio access network (RAN) intelligent controller as defined in Open Radio Access Networks (O-RAN) specifications, and trained model parameters can be sent to the BS. In yet another embodiment, the model training can be performed offline (e.g., model training is performed outside of the network), and the trained model parameters can be sent to the BS or a network entity. Part of or all the configuration information can be broadcasted as a part of cell-specific information, for example by system information such as the master information block (MIB), system information block 1 (SIB1) or other SIBs. Alternatively, part of or all the configuration information can be sent as UE-specific signaling, or group-specific signaling. More details about the signaling method are discussed in the following “Configuration method” section.

At operation 403, the BS sends the measurement reporting related configuration information to the UE such as the setting the triggering conditions, inference interval, reporting intervals of the measurement reporting. Inference interval refers to the interval of time periods at which the UE may perform the ML inference, it is defined within the reportConfigNR parameter. Part of or all the measurement reporting configuration information is sent to specific UE's using remote radio control (RRC) messages once or at any specific needed time. More details about the signaling method are discussed in the following “AI/ML assisted Measurement Reporting configuration method” section.

At operation 404, the BS receives the measurement reports from the UE's that are triggered by the ML inference at the UE. In one example, the measurement report sent can include additional supporting information from the UE suggesting possible neighbor cells to do the handover operation. More information on the measurement report triggering conditions can be found in the following “AI/ML assisted Measurement Reporting event method” section. Details about the contents of the measurement report can be found in the following embodiment “design of the measurement report contents.”

At operation 405, the BS receives the updated AI/ML model parameters based on local training from one or multiple UEs, where a UE may perform the model training based on local data available at that UE. The local information at the UE may include but is not limited to UE location, UE trajectory, estimated downlink (DL) channel status, etc. The updated model parameters received by the BS are based on the configuration parameters configuration (e.g., whether updated model parameters sent from the UE will be used or not). Details about the signaling method are discussed in the following “Reporting UE model parameters” section.

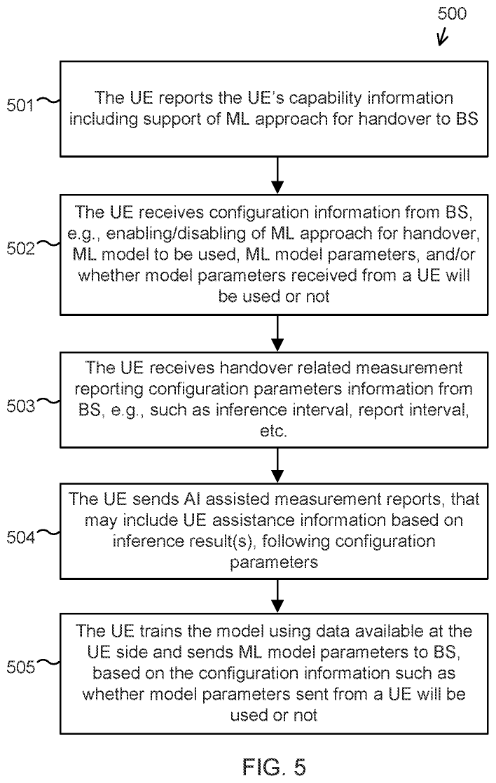

FIG. 5 illustrates a high level flowchart for an example of UE operation to support ML/AI techniques for optimal handover management, where UE performs the inference operation according to various embodiments of this disclosure. The embodiment of FIG. 5 is for illustration only. Other embodiments of the process 500 could be used without departing from the scope of this disclosure.

FIG. 5 illustrates an example of a method 500 for operations at UE side to support handover management using ML/AI techniques. At operation 501, a UE reports the UE's AI/ML capability to support AI/ML assisted handover management to the BS, such as support of AI/ML model training and/or inference as outline in “configuration method” section.

At operation 502, a UE receives configuration information, including information related to ML/AI techniques such as enabling/disabling of ML approach for handover, ML model to be used, and/or the trained model parameters. Part of or all the configuration information can be broadcasted as a part of cell-specific information, for example by system information such as MIB, SIB1 or other SIBs. Alternatively, part of or all the configuration information can be sent as UE-specific signaling, or group-specific signaling. More details about the signaling method are discussed in the following “Configuration method” section.

At operation 503, the UE receives the measurement reporting related configuration information from the BS such as the setting the triggering conditions, reporting intervals of the measurement reporting. Part of or all the measurement reporting configuration information is received through RRC messages such as RRC reconfiguration once or at any specific needed time. More details about the signaling method are discussed in the following “A1/ML assisted Measurement Reporting configuration method” section.

At operation 504, the UE performs the inference based on the received configuration information, measurement reporting parameters and local data. For example, the UE follows the configured ML model and model parameters, measurement reporting parameters and uses local data and/or data sent from the BS to perform the inference operation. Based on the outcome of the inference, the UE sends the measurement report to the BS. More details about it can be found in the “A1/ML assisted Measurement Reporting event method” section. The contents of the measurement may or may not include additional supporting information which can also be an outcome of the ML model inference engine in some examples as illustrated in the following embodiment “design of the measurement report contents”. At operation 505, the UE may send the updated A1/ML model parameters based on local training to BS, i.e., model training at UE based on the local information which may include but is not limited to UE location, UE trajectory, etc. The model parameters are sent according to the configuration of whether the model parameter updates will be used at the BS to update the global model or not. More details about the signaling method are discussed in “Reporting UE model parameters” section.

The configuration information related to ML/AI techniques (e.g., at operations 401, 402, 501, and/or 502 above) can include one or multiple of the following information.
Enabling/disabling of ML approach for handover
In one embodiment, the configuration information can include whether ML/AI techniques for handover management use case is enabled or disabled.
ML model/algorithm and model parameters
The configuration information can include which ML/AI model or algorithm to be used for the handover management use case along with the model parameters of ML algorithms that may or may not be limited to the loss function, the initial/global parameters for the ML model, whether the UE is configured for the local training and/or reporting, the number of iterations for local training before polling, local batch size for each learning iteration, and/or learning rate, etc.

In one embodiment, part of or all the configuration information can be broadcasted as a part of cell-specific information, for example by system information such as MIB, SIB1 or other Ms. Alternatively, a new SIB can be introduced for the indication of configuration information. For example, the enabling/disabling of ML approach, which ML model to be used, and/or model parameters for handover operation can be broadcasted. In another example, the updates of model parameters can be broadcasted. In yet another example, the configuration information of neighboring cells, e.g., the enabling/disabling of ML approach, ML model and/or model parameters for handover management of neighboring cells, can be indicated as part of the system information, e.g., in MIB, SIB1, SIB3, SIB4 or other SIBs.

In another embodiment, part of or all the configuration information can be sent by UE-specific signaling such as UE-specific RRC signaling. In yet another embodiment, part of or all the configuration information can be sent by group-specific signaling. A UE group-specific radio network temporary identifier (RNTI) can be configured, e.g., using value 0001-FFEF or the reserved value FFF0-FFFD. The group-specific RNTI can be configured via UE-specific RRC signaling.

The information element (IE) ReportConfigNR specifies criteria for triggering of an NR measurement reporting event based on cell measurement results, which can either be derived based on SS/PBCH block or CSI-RS. [1]

The measurement reporting configuration parameters set by the BS to a UE belong to the ReportConfigNR that includes but is not limited to as reportAmount, reportOnLeave, timeToTrigger, reportAddNeighMeas, reportInterval.

In this disclosure, an additional field labelled InferenceInterval is added to ReportConfigNR, specifying the periodic time interval at which UE may perform the AI/ML inference. Possible values could be [10, 20, 30, 40, 60, 80, 100, 200] milliseconds (ms).

Additional fields that may be added to the ReportConfigNR are indicated in boldface type in the exemplary Abstract Syntax Notation One (ASN.1) example below:

| | |
|---|---|
| eventA7 | SEQUENCE { |
| reportOnLeave | BOOLEAN |
| timeToTrigger | TimeToTrigger, |

```
  },
  ...
},
```

| | |
|---|---|
| rsType | NR-RS-Type, |
| reportInterval | ReportInterval |

| | |
|---|---|
| reportAmount | ENUMERATED {r1, r2, r4, r8, r16, r32, r64, |
| | infinity}, |
| inferenceInterval | INTEGER (10,20,30,..100) |
| reportQuantityCell | MeasReportQuantity, |
| maxReportCells | INTEGER (1..maxCellReport), |
| reportQuantityRS-Indexes | measReportQuantity |
| maxNrofRS-IndexesToReport | INTEGER (1..maxNrofIndexesToReport) |
| includeBeamMeasurements | BOOLEAN, |
| reportAddNeighMeas | ENUMERATED {setup} |
| mlinferenceinfo | ENUMERATED |

At the UE, using the local data which includes but is not limited to velocity, location, RSRP, RSRQ, SINR of serving cell and neighboring cells, ML inference is done which determines the triggering of Event A7 as described below.

The UE Shall:
Consider measurement results of the serving cells Ms and neighboring cells Mn
Do AI/ML inference periodically as given by Inflnt, by taking Ms, Mn as input and generate output aₘₗ
Consider the entering condition for this event to be satisfied when condition A7-1, as specified below, is fulfilled;
Consider the leaving condition for this event to be satisfied when condition A7-2, as specified below, is fulfilled;
A7-1 (Entering condition)
aₘₗ(t₁)=aₘₗ(tᵢ₊₁)=1, i.e., output of AWL agent changes from 0→1
A7-2 (Leaving condition)
aₘₗ(t₁)=aₘₗ(tᵢ₊₁)=0, i.e., output of AWL agent changes from 1→0

The variables in the formula are defined as follows:

Ms is the measurement result of the serving cell, not taking into account any offsets.

Mn is the measurement result of the neighbouring cell, not taking into account any offsets.

t₁ is an instance in time.

Inflnt is the inference interval parameter for this event (i.e., inferenceinterval as defined within reportConfigNR for this event).

Ms, Mn are expressed in dBm in case of RSRP, or in dB in case of RSRQ and RS-SINR.

Infint expressed in ms.

ML model parameters reported by UE to BS (e.g., at operation 405, 505) can include the updates of model parameters based on local training at UE side, which can be used for model updates, e.g., in federated learning approaches. The report of the updated model parameters can depend on the configuration. For example, if it is configured that the model parameter updates from the UE would not be used, the UE may not report the model parameter updates. On the other hand, if it is configured that the model parameter updates from the UE may be used for model updating, the UE may report the model parameter updates.

The reporting of the model parameters can be via PUCCH and/or PUSCH. A new UCI type, a new PUCCH format and/or a new MAC CE can be defined for the model parameters report.

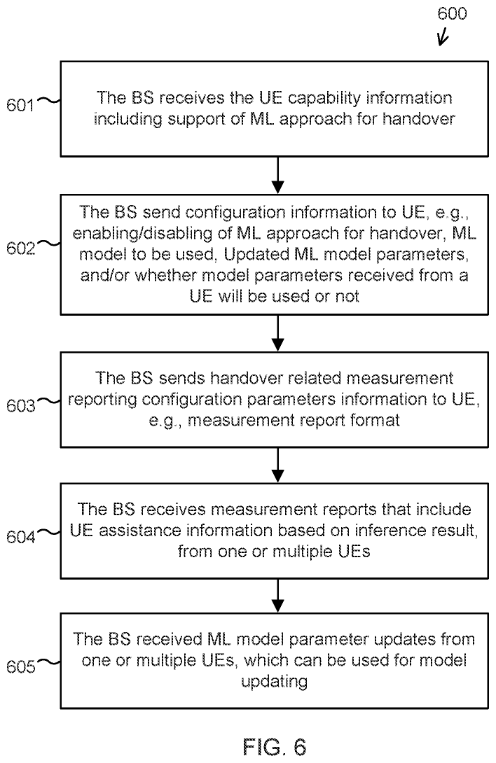

FIG. 6 illustrates a high level flowchart for an example of BS operation to support ML/AI techniques handover, with new design of measurement report contents according to various embodiments of this disclosure. The embodiment of FIG. 6 is for illustration only. Other embodiments of the process 600 could be used without departing from the scope of this disclosure.

In this embodiment, the design of the measurement report contents is discussed. In current NR, the measurement report contents include RSRP, RSRQ, and/or SINR values. In this embodiment, new information can be added to the measurement report contents.

FIG. 6 is an example of a method 600 for operations at BS side to support the design of measurement report contents using ML/AI techniques. At operation 601, a BS receives the UE capability information, e.g., the support for the ML approach based measurement report contents. At operation 602, the BS sends the configuration information to UE, which can include information about the AI/ML model used for the federated learning, ML/AI related configuration information such as enabling/disabling of ML approach for handover, the trained model parameters of the model, and/or whether the local updated model parameters received from a UE will be used or not, etc. In one embodiment, the model training can be performed at BS side. Alternatively, the model training can be performed at another network entity (e.g., RAN Intelligent Controller as defined in O-RAN), and trained model parameters can be sent to the BS. In yet another embodiment, the model training can be performed offline (e.g., model training is performed outside of the network), and the trained model parameters can be sent to the BS or a network entity. Part of or all the configuration information can be broadcasted as a part of cell-specific information, for example by system information such as MIB, SIB1 or other SIBS. Alternatively, part of or all the configuration information can be sent as UE-specific signaling, or group-specific signaling. At operation 603, the BS sends the measurement reporting related configuration information to the UE such as enabling reporting additional information in the measurement report contents. Part of or all the measurement reporting configuration information can be sent to specific UE using RRC messages once or at any specific needed time.

At operation 604, BS receives the measurement reports from the UE. The contents of the measurement report sent to the BS when triggered can be also set in IE ReportConfigNR. Along with sending a combination RSRP, RSRQ, SINR values in the report or an optional field of sending neighboring cell RSRP values, we propose to introduce an additional field “mlinferenceinfo.” In one example, this field can include the information such as UE's preference regarding whether the handover should be performed, and/or which cell it prefers to handover to. At operation 605, the BS receives the updated AI/ML model parameters based on local training from one or multiple UEs, based on the configuration parameters.

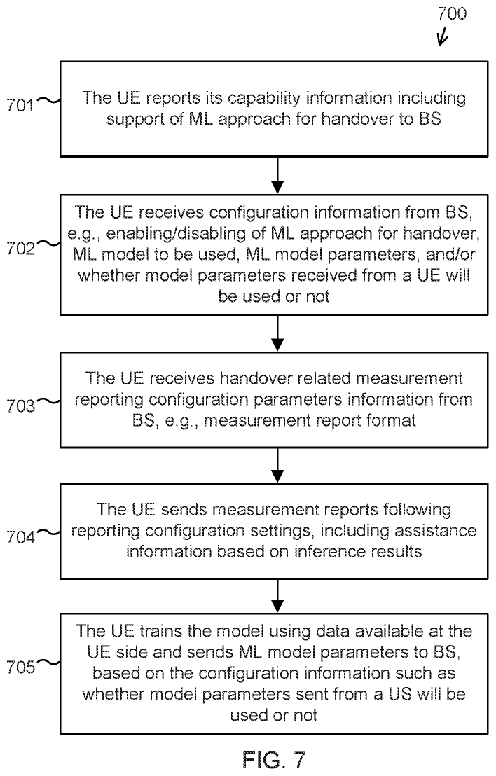

FIG. 7 illustrates a high level flowchart for an example of UE operation to support ML/AI techniques for handover, with new design of measurement report contents according to various embodiments of this disclosure. The embodiment of FIG. 7 is for illustration only. Other embodiments of the process 700 could be used without departing from the scope of this disclosure.

FIG. 7 illustrates an example of a method 700 for operations at UE side to support design of measurement report contents using ML/AI techniques. At operation 701, a UE reports the UE's AI/ML capability, e.g., the support of AI/ML assisted measurement reporting to the BS, the support of AI/ML model training and/or inference.

At operation 702, a UE receives configuration information, including information related to ML/AI techniques such as enabling/disabling of ML approach for handover, ML model to be used, and/or the trained model parameters. Part of or all the configuration information can be broadcasted as a part of cell-specific information, for example by system information such as MIB, SIB1 or other SIBs. Alternatively, part of or all the configuration information can be sent as UE-specific signaling, or group-specific signaling.

At operation 703, the UE receives the measurement reporting related configuration information from the BS such as enabling reporting additional information in the measurement report contents. Part of or all the measurement reporting configuration information is received through RRC messages once or at any specific needed time.

At operation 704, the UE performs the inference based on the received configuration information, measurement reporting parameters and local data. For example, the UE follows the configured ML model, model parameters, measurement reporting parameters and uses local data and/or data sent from the BS to perform the inference operation. Based on the outcome of the inference, the UE sets the contents the measurement reports sent to the BS. Along with sending a combination RSRP, RSRQ, SINR values in the report or an optional field of sending neighboring cell RSRP values, the report might include an additional field “mlinferenceinfo” depending on the configuration. In one example, this field can include the information such as UE's preference regarding whether the handover should be performed, and/or which cell it prefers to handover to. At operation 705, UE may send the updated AI/ML model parameters based on local training to BS, according to the configuration of whether the model parameter updates will be used at the BS to update the global model or not.

In the above embodiment, the framework with inference performed at UE side has been disclosed. Alternatively, the inference can be performed at BS or a network entity different from UE.

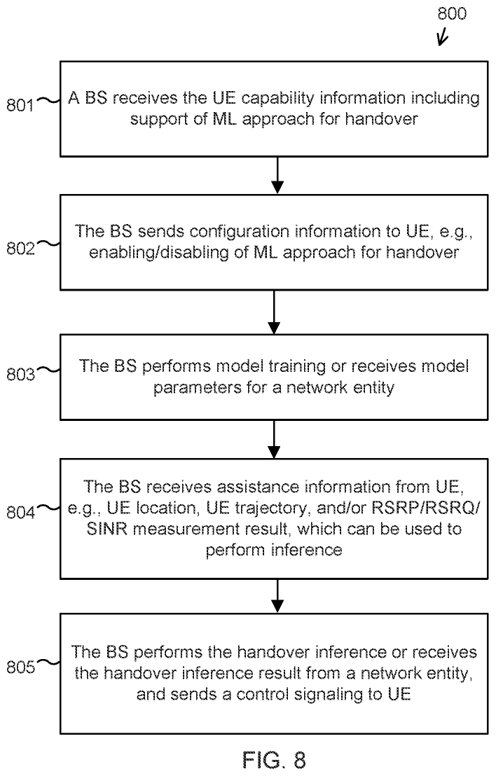

FIG. 8 illustrates a high level flowchart for an example of BS operation to support AI/ML techniques for handover, where no inference is performed at UE according to various embodiments of this disclosure. The embodiment of FIG. 8 is for illustration only. Other embodiments of the process 800 could be used without departing from the scope of this disclosure.

FIG. 8 is an example of a method 800 for operations at BS side for support of AI/ML techniques for handover. At operation 801, a BS receives the UE capability information including support of AI/ML approach for handover. At operation 802, the BS sends configuration information to UE, including the enabling/disabling of AI/ML approach for handover. Part of or all the configuration information can be broadcasted as a part of cell-specific information, for example by system information such as MIB, SIB1 or other SIBS. Alternatively, part of or all the configuration information can be sent as UE-specific signaling, or group-specific signaling. At operation 803, the BS performs model training, or receives model parameters from a network entity. In one embodiment, the model training can be performed at BS side. Alternatively, the model training can be performed at another network entity, and trained model parameters can be sent to the B S. In yet another embodiment, the model training can be performed offline (e.g., model training is performed outside of the network), and the trained model parameters can be sent to the BS or a network entity. At operation 804, the BS receives assistance information from UE, e.g., UE location, UE trajectory, and/or RSRP/RSRQ/SINR measurement value. One or multiple of the information can be used for inference operation.

At operation 805, the BS performs the inference or receives the inference result from a network entity, where the inference result can include whether handover should be performed for a UE, and/or which cell the UE should perform handover to. Based on the inference result, the BS sends a control signaling to the UE, regarding the handover operation, e.g., whether handover should be performed for a UE, and/or which cell the UE should perform handover to. The handover command can be sent via PDCCH and/or PDSCH. For example, a new DCI format can be introduced to carry the handover command, where the CRC is scrambled by C-RNTI. For example, the size of the new DCI format can be L1 bits, which is different from DCI format 0_0 or 0_1. Alternatively, a group-common DCI can be adopted to indicate the handover command to a group of UEs. For example, these UEs can be located nearby to each other and/or have similar trajectory. The group-common DCI can have the same format as the existing DCI, e.g., DCI format 2_2, or can use a new DCI format. A new group-specific RNTI can be defined, e.g., using value 0001-FFEF or the reserved value FFF0-FFFD. The BS can configure the UE with the group-specific RNTI via RRC configuration. Another example is to use NR handover command message to carry this handover command.

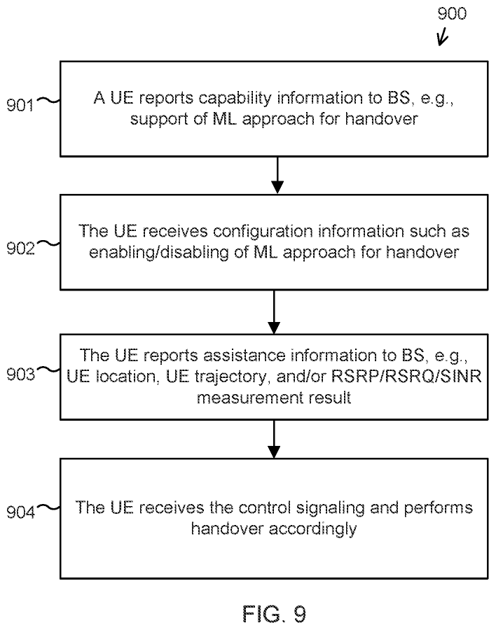

FIG. 9 illustrates a high level flowchart for an example of UE operation to support AI/ML techniques for handover, where no inference is performed at UE according to various embodiments of this disclosure. The embodiment of FIG. 9 is for illustration only. Other embodiments of the process 900 could be used without departing from the scope of this disclosure.

FIG. 7 is an example of a method 600 for operations at UE side to support AI/ML techniques for handover. At operation 602, a UE reports its capability information to BS, which can include the support of AI/ML approach for handover. At operation 604, a UE receives configuration information, including information related to ML/AI techniques such as enabling/disabling of ML approach for handover. At operation 606, the UE reports the assistance information to BS, e.g., UE location, UE trajectory, and/or RSRP/RSRQ/SINR measurement result. The assistance information can be carried in PUCCH and/or PUSCH. A new UCI type, a new PUCCH format and/or a new MAC CE can be defined for the assistance information report. Regarding the triggering method for the UE assistance information report, in one embodiment, the report can be triggered periodically, e.g., via UE-specific RRC signaling. In another embodiment, the report can be semi-persistence or aperiodic. For example, the report can be triggered by the DCI, where a new field (e.g., 1-bit triggering field) can be introduced to the DCI for the report triggering. In yet another example, the triggering event defined in NR (e.g., events A1-A6, B1, B2) and/or the event A7 designed above for handover measurement report can be reused for the triggering of UE assistance information report. In one example, an IE similar to IE CSI-ReportConfig can be introduced for the report configuration of UE assistance information to support ML/AI techniques. At operation 608, the UE receives control signaling from BS, and performs the handover operation accordingly. In one example, the control signaling can include command determined based on the inference result. The UE can receive the handover indication from BS such as whether handover should be performed and/or which cell to handover to if handover is to be performed, and perform the handover operation following the indication.

For illustrative purposes, algorithm steps are described serially herein. However, some of the steps may be performed in parallel to each other. The above operation diagrams illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although this disclosure has been described with an exemplary embodiment, various changes and modifications may be suggested to one skilled in the art. It is intended that this disclosure encompass such changes and modifications as fall within the scope of the appended claims.

What is claimed is:

1. A user equipment (UE), comprising:
a transceiver configured to receive configuration information for a machine learning handover event; and
a processor operably coupled to the transceiver, the processor executing an artificial intelligence/machine learning agent and configured to determine whether to initiate handover according to the received configuration information for the machine learning handover event based on one or more of
signal quality for one or more serving base stations,
signal quality for one or more neighboring base stations,
a velocity of the UE,
a location of the UE, and
a trajectory of the UE.

2. The UE of claim 1, wherein the configuration information for the machine learning handover event includes at least one of an inference interval specifying a trigger time at which the artificial intelligence/machine learning agent determines whether to initiate handover or a reporting interval specifying a periodicity at which the UE reports machine learning parameters for machine learning handover.

3. The UE of claim 1, wherein the configuration information for the machine learning handover event includes machine learning inference information specifying factors used by the artificial intelligence/machine learning agent to determine whether to initiate handover.

4. The UE of claim 1, wherein the determination of whether to initiate handover is based on a new event A7 defined by an event, a trigger condition, and a cancel condition.

5. The UE of claim 1, wherein the transceiver is further configured to transmit, to a base station, UE capability information including support for machine learning handover.

6. The UE of claim 1, wherein the configuration information for the machine learning handover event includes one or more of enabling or disabling of machine learning handover, a machine learning model to be used for machine learning handover, updated machine learning parameters for machine learning handover, or whether parameters received from the UE will be used for machine learning handover.

7. The UE of claim 1, wherein the configuration information is transmitted via UE-specific radio resource control (RRC) signaling, and wherein model parameters for a machine learning model to be used for machine learning handover are transmitted via one of physical uplink control channel (PUCCH), physical uplink shared channel (PUSCH), uplink control information (UCI), or medium access control control element (MAC CE).

8. The UE of claim 1, wherein the configuration information indicates a parameter for a machine learning handover inference information to be reported in measurement reporting.

9. The UE of claim 1, wherein control signaling initiating handover is via one of
a downlink control information (DCI) in one of a physical downlink control channel (PDCCH) or a physical downlink shared channel (PDSCH),
a group-common DCI,
based on a group-specific radio network temporary identifier (RNTI) configured by remote resource control (RRC) signaling, or
a handover command message.

10. The UE of claim 1, wherein the determination of whether to initiate handover is made based on assistance information including one of UE location and UE trajectory, wherein the assistance information is transmitted via one of physical uplink control channel (PUCCH), physical uplink shared channel (PUSCH), uplink control information (UCI), or medium access control—control element (MAC-CE), and wherein the assistance information is transmitted one of periodically, semi-persistently, or aperiodically.

11. A base station (BS), comprising:
a transceiver configured to transmit configuration information for a machine learning handover event; and
a processor operably coupled to the transceiver, the processor executing an artificial intelligence/machine learning agent and configured to determine whether to initiate handover according to the received configuration information for the machine learning handover event based on one or more of
signal quality for one or more serving base stations,
signal quality for one or more neighboring base stations,
a velocity of the UE,
a location of the UE, and
a trajectory of the UE.

12. The BS of claim 11, wherein the configuration information for the machine learning handover event includes at least one of an inference interval specifying a trigger time at which the artificial intelligence/machine learning agent determines whether to initiate handover or a reporting interval specifying a periodicity at which the UE reports machine learning parameters for machine learning handover.

13. The BS of claim 11, wherein the configuration information for the machine learning handover event includes machine learning inference information specifying factors used by the artificial intelligence/machine learning agent to determine whether to initiate handover.

14. The BS of claim 11, wherein the determination of whether to initiate handover is based on a new event A7 defined by an event, a trigger condition, and a cancel condition.

15. The BS of claim 11, wherein the transceiver is further configured to receive, from the UE, UE capability information including support for machine learning handover.

16. The BS of claim 11, wherein the configuration information for the machine learning handover event includes one or more of enabling or disabling of machine learning handover, a machine learning model to be used for machine learning handover, updated machine learning parameters for machine learning handover, or whether parameters received from the UE will be used for machine learning handover.

17. The BS of claim 11, wherein the configuration information is transmitted via UE-specific radio resource control (RRC) signaling, and wherein model parameters for a machine learning model to be used for machine learning handover are transmitted via one of physical uplink control channel (PUCCH), physical uplink shared channel (PUSCH), uplink control information (UCI), or medium access control—control element (MAC-CE).

18. The BS of claim 11, wherein the configuration information indicates a parameter for a machine learning handover inference information to be reported in measurement reporting.

19. The BS of claim 11, wherein control signaling initiating handover is via one of
a downlink control information (DCI) in one of a physical downlink control channel (PDCCH) or a physical downlink shared channel (PDSCH),
a group-common DCI,
based on a group-specific radio network temporary identifier (RNTI) configured by remote resource control (RRC) signaling, or
a handover command message.

20. The BS of claim 11, wherein the determination of whether to initiate handover is made based on assistance information including one of UE location and UE trajectory, wherein the assistance information is transmitted via one of physical uplink control channel (PUCCH), physical uplink shared channel (PUSCH), uplink control information (UCI), or medium access control—control element (MAC-CE), and wherein the assistance information is transmitted one of periodically, semi-persistently, or aperiodically.
